(19) United States
(12) Patent Application Publication
(10) Pub. No.: US 2008/0209566 A1
(43) Pub. Date: Aug. 28, 2008

(54) Method and System For Network Vulnerability Assessment

(75) Inventor: Nitzan Ziv, Ramat Gan (IL)

Correspondence Address: MARSTELLER & ASSOCIATES, P O BOX 803302, DALLAS, TX, 75380-3302, US

(73) Assignee: RAW ANALYSIS LTD., Petach Tikva (IL)

(21) Appl. No.: 11/993,993

(22) PCT Filed: Jun. 22, 2006
(86) PCT No.: PCT/IL2006/000730

§ 371 Date: Dec. 27, 2007

(30) Foreign Application Priority Data
Jun. 30, 2005 (IL) 169483

(51) Int. Cl. G06F 21/00

(52) U.S. Cl. 726/25

(57) ABSTRACT

The present invention relates to a simultaneous system for finding and assessing vulnerabilities in a network, which comprises: A. A mapping unit for: (a) scanning the network, and each time a new element is found, reporting its IP address to a profiling unit; (b) sequentially receiving from the profiling unit profile records of said newly found elements; (c) sequentially extracting tables from those elements which their profile record indicates that they are of the network equipment type; and (d) sequentially reporting to a modeling and simulating unit topology records which include said found IPs, and for those elements being of a network equipment type, said topology records also include said extracted tables; B. A profiling unit for sequentially receiving IP addresses of network elements from the mapping unit, investigating each of said elements, forming a profile record for each of said elements, and sequentially transferring said profile records to both the mapping unit and to a vulnerability assessment unit; C. A vulnerability assessment unit for: (a) sequentially receiving profile records from the profiling unit; (b) determining a list of those vulnerability tests that have to be performed on each element; (c) performing for each element those vulnerability tests that are included in its corresponding list, and determining for each test a passed or failed result; and (d) sequentially reporting to an modeling and simulation unit for each performed test, the IP of the element, the identity code of the element, and the passed or failed result; and D. A modeling and simulation unit for: (a) sequentially receiving topology records from the mapping unit, and each time a topology record is received, adding or subtracting respectively the corresponding element from a model of the network which is maintained at the modeling and simulation unit; (b) sequentially receiving from the vulnerability assessment unit vulnerability test (VT) results; and (c) sequentially analyzing the model currently existing at the modeling and simulation unit for the possibility of exploiting vulnerabilities of the network.

### FIELD OF THE INVENTION

The present invention relates to the field of computer network security. More particularly, the invention relates to a method for assessing network potential threats.

### BACKGROUND OF THE INVENTION

In recent years network security has become a main issue for many companies who have come to depend on their network for communication, business relations, customer service, and so on. As global data transitions expand every day, so has the number of reported attacks on networks world wide. While the motivation of hackers world wide varies tremendously, from profit seekers to political ideologists or just plain fun, the outcome of the attacks may be devastating. Therefore, it is not surprising that many companies have invested huge amounts of capital in securing their networks. A partial solution for some of the threats may be found in software and hardware security products, many of which are easily accessible for purchase and installation. Some of these products are very popular and commonly known, like Antivirus, Firewall, and IDS (Intrusion Detection Systems). However, most of these products have known vulnerabilities that a hacker may try to take advantage of.

One of the apparent disadvantages of most networks today is the use of common network elements, a fact that compromises the security since the vulnerabilities of these elements have become public and known. Most of the vulnerabilities have known obstructions that can be easily implemented in networks. For example, patches that minimize security breaches in the Microsoft® operating systems are available on Microsoft® web page. The same applies to hardware elements in a network, for example, a router may be configured differently to disallow unauthorized access from the Internet to sensitive information. In conclusion, when dealing with network security, most of the efforts should be concentrated in finding the breaches and vulnerabilities, once this is done, the solutions in general are abundant and easily accessible.

One of the methods used today for detecting network vulnerabilities involves mapping the network and all its elements. Since all elements of the network are connected directly or indirectly, wherein the connection may involve both logical and physical aspects, the mapping allows an administrator to understand which element is connected to which element, and which element may access other elements. The significance of such a method is apparent when one of the elements in the network has been compromised and an analysis has to be made as to the possibilities of the intruder to continue penetrating to other elements. Furthermore, by mapping the whole network, it is possible to see some of the security breaches, their significance to the network security, and suggest solutions to prevent these breaches.

U.S. Pat. No. 6,415,321 discloses a system and method for configuring the rules of an IDS (Intrusion Detection System) based on the potential vulnerability of the network and based on the network map. The mapping of the network is based on receiving information from the elements by querying them. Determination of vulnerability of the network is based on the analysis of the information received from the queries and on the network mapping. The patent does not disclose if other elements of the network can be changed according to the network map, or how to configure the network elements differently for better security.

U.S. Pat. No. 6,711,127 discloses a system and method for determining the likelihood of an intrusion to elements of a network, and for determining which action to take for reducing the likelihood of an intrusion to elements of a network. The patent discloses a system and method for analyzing each individual element alone while supplying individual solutions to each element. The patent lacks discloser of a method that analyzes the impact of one security breach in one element on other security breaches and on other elements. It is a well known fact that network security depends among others things, on the integration of security elements in a network, i.e., configuring each security element in a network individually may not produce the sought outcome of the whole network security.

WO 2004/031953 discloses a method for risk detection and analysis of a computer network. The application further discloses a method for automatic vulnerability assessment in a computer network by mapping the network, creating a model of the network, simulating possible attacks of the network, calculating the probability of the attacks, and generating corresponding consequences of such attacks. Nevertheless, the method describes an analytic approach where each time the network is changed and the mapping varies, an assessment is required for the whole network. The method analyzes vulnerabilities by assessing each element connectivity to all other elements of the network requiring an implementation complexity of O(N³) or complexity of O(N²) at best, where N is the number of elements available in the network. Since networks are dynamic and change constantly, a long and complicated implementation causes long calculations, or worse, some of the changes may be overlooked by the busy system.

It is an object of the present invention to provide a method which is capable of assessing the impact of one security breach in one element on other elements of the computer network, without reassessing the whole network each time the network is changed.

It is another object of the present invention to provide a method which is capable of assessing the vulnerability of the network using fewer calculations.

It is still another object of the present invention to provide a system which is capable of assessing the vulnerability of the network in real time.

It is still another object of the present invention to provide a system which is capable of determining the optimum actions to be taken for reducing the vulnerability of the network.

Other objects and advantages of the invention will become apparent as the description proceeds.

### SUMMARY OF THE INVENTION

The present invention relates to a simultaneous system for finding and assessing vulnerabilities in a network, which comprises: A. A mapping unit for: (a) scanning the network, and each time a new element is found, reporting its IP address to a profiling unit; (b) sequentially receiving from the profiling unit profile records of said newly found elements; (c) sequentially extracting tables from those elements which their profile record indicates that they are of the network equipment type; and (d) sequentially reporting to a modeling and simulating unit topology records which include said found IPs, and for those elements being of a network equipment type, said topology records also include said extracted tables; B. A profiling unit for sequentially receiving IP addresses of network elements from the mapping unit, investigating each of said elements, forming a profile record for each of said elements, and sequentially transferring said profile records to both the mapping unit and to a vulnerability assessment unit; C. A vulnerability assessment unit for: (a) sequentially receiving profile records from the profiling unit; (b) determining a list of those vulnerability tests that have to be performed on each element; (c) performing for each element those vulnerability tests that are included in its corresponding list, and determining for each test a passed or failed result; and (d) sequentially reporting to a modeling and simulation unit for each performed test, the IP of the element, the identity code of the element, and the passed or failed result; and D. A modeling and simulation unit for: (a) sequentially receiving topology records from the mapping unit, and each time a topology record is received, adding or subtracting respectively the corresponding element from a model of the network which is maintained at the modeling and simulation unit; (b) sequentially receiving from the vulnerability assessment unit VT results; and (c) sequentially analyzing the model currently existing at the modeling and simulation unit for the possibility of exploiting vulnerabilities of the network.

Preferably, each of the mapping, profiling, and vulnerability assessment units operate on only one element at each given time, and the modeling and simulation unit operates on the accumulated network model structure at each given time.

Preferably, each topology record of a network element comprises at least the IP of a network element.

Preferably, when the element is of a network equipment type, each topology record further comprises also the tables of the element.

Preferably, each profile record of a network element comprises at least the parameters that characterize the specific element.

Preferably, each profile record of a network element comprises one or more of the following parameters: the IP address of the element, the operating system name and version open ports, running services, installed patches, configuration, registry configuration, supported protocols, running services detailed information, vendor, build number, and hardware identification. Preferably, the analyzing by the modeling and simulation unit involves the step of providing a vulnerability grade to each element of the model, based on the received vulnerability test results.

Preferably, the analyzing by the modeling and simulation unit further involves, best on the vulnerability grade given to each element, the step of finding vulnerable routes for attacking the network elements.

Preferably, each of the mapping, profiling, vulnerability assessment, and modeling and simulation units comprise: (a) an input queue for sequentially receiving inputs from one or more other units; (b) an output queue for sequentially outputting outputs to one or more other units; (c) a database; (d) a storage for storing temporary processing results; and (e) a processor for: receiving inputs from other units, using data in the database and the storage in order to obtain results, and for sequentially outputting results to other units.

Preferably, when the unit is a mapping unit, the database contains commands for extracting tables from networking equipments, the storage contains tables and history of detected IP results for comparison, the input queue contains sequential profile records, and the output queue contains IP addresses of detected elements to be provided to the mapping unit, or topology records to be provided to the modeling and simulation unit.

Preferably, when the unit is a profiling unit, the database contains OS information, vendor information, and other information relating to the how to determine the profile of each element, the storage contains the profiles obtained from the already investigated network elements for comparison, the input queue contains IPs that are received from the mapping unit 10, and the output queue contains sequential profile records that are conveyed to the VA unit and to the mapping unit.

Preferably, when the unit is a vulnerability assessment unit, the database contains the tests that have to be performed, and a table indicating the specific tests that have to be run on each element, the storage contains the accumulated vulnerability test results already obtained for each network element for comparison, the input queue contains profile records that are received from the profiling unit, and the output queue contains sequential vulnerability test results that are obtained and conveyed to the modeling and simulation unit.

Preferably, when the unit is a simulation and modeling unit, the database contains the information relating to the impact results of test failures on the vulnerability grade given to each element; the storage contains the accumulated model already obtained for each network element, the grade given to each element, and the accumulated simulation results; the input queue contains vulnerability test results that are received from the vulnerability assessment unit; and the output queue contains sequential results that are obtained and conveyed to the user interface.

### BRIEF DESCRIPTION OF THE DRAWINGS

In the drawings:

FIG. 1 is a block diagram generally illustrating an embodiment of the invention.

FIG. 2 is a block diagram of an exemplary network that can be analyzed by the present invention;

FIG. 3 is a block diagram of the exemplary network of FIG. 2, during a temporary stage of the analysis by the system of the present invention; and

FIG. 4 shows in block diagram form the structure of each of the four units of the system of the present invention.

### DETAILED DESCRIPTION OF PREFERRED EMBODIMENTS

The invention involves the use of the following terms:

Profile—The description of a network element, such as its type (server, PC, router, switch, firewall, etc.), its operating system, operating system version number, configuration, active services, open ports, etc.

Vulnerability Assessment—Determining the possible threats able to intrude or harm a network element.

Mapping—Finding network addresses of the elements in a network, and determining the physical and logical connections between the various elements.

The present invention provides a method and system for performing threat analysis of a communication network and all its components. The system of the present invention is characterized in that the analysis is performed in an incremental manner, while most operations of the system are focused on one element, therefore resulting in a significant reduction of the number of calculations in comparison with similar systems of the prior art. While in the prior art an analysis of an average network could take up to several days, the analysis by the system of the present invention may take several seconds, or up to several minutes.

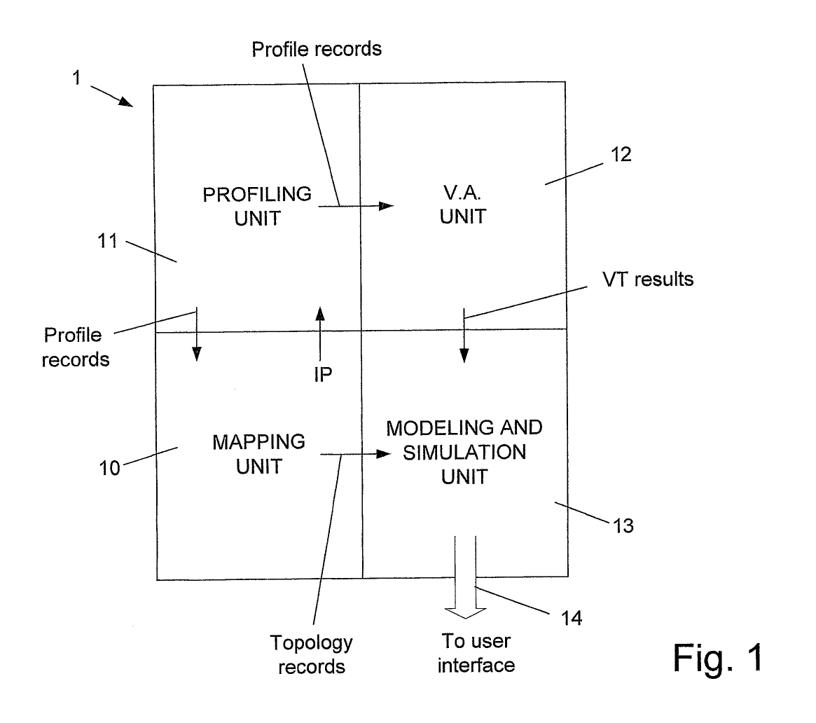

FIG. 1 generally describes the structure of the system of the present invention. The system comprises four main units, as follows:
a. A mapping unit 10 which generally scans the network, finds all the components of the network which have an IP address (hereinafter, “network elements”, or briefly “elements”), and determines all the physical and logical links between all the found network elements. By “logical links”, it is meant switching, routing, traffic shaping, content filtering, and AAA (authentication, authorization, and accounting).
b. A profiling unit 11, which receives all the IP addresses that have been found by the mapping unit, and determines separately for each network element its profile. The profile unit forms, for each element, a profile record which includes the IP of the element and the parameters that characterize the specific element. It should be noted that the parameters are also specific to the type of the element. The profile unit provides each profile record to both the VA unit 12 and to the mapping unit 10.
c. The vulnerability assessment unit 12 (hereinafter, the “VA unit”) receives sequentially profile records from the profiling unit 11. From the profile records, the VA unit concludes a list of specific vulnerability tests (hereinafter “VT”) that have to be performed for the specific element. Having the list of VTs, the VA unit continues by performing those concluded tests on that element, resulting with a true or false (passed or fail) result. A true result means that the element is vulnerable for that test, and a false result means that the element is not vulnerable for that test. The VA unit maintains a record of the recent test results. Upon having a test result, it compares the new result with the recent result for that specific test. If a difference is found in the true/false result of a test, this difference is reported to the modeling & simulation unit (hereinafter “MS unit”) 13. More particularly, the VA unit 12 transfers to the MS unit 13 a report which contains an IP address of the relevant element, the port of the element on which the test has been performed, a VT# and a true or false status. The VA unit contains several data bases which contain fingerprints of various system elements, description of known vulnerabilities, and the description of the various VT tests.
d. The MS unit 13 sequentially receives from the VA unit 12, VT results. It also receives sequentially from the mapping unit records relating to incremental changes in the network topology (hereinafter “topology records”). More particularly each topology record includes an IP address, links from said IP address to other network elements, and in case the element is a network equipment, (such as a switch, a router, or a firewall), the topology record also includes the relevant routing and switching rules. From the topology records, the MS unit incrementally builds a virtual model of the network. Such a topology record may also involve update to the already existing model. Having the model, and having the VT results, each model update which is received (either from the mapping unit 10, or from the VA unit 12) is followed by the performance of an analysis relating to the possibilities of exploiting vulnerabilities of the system. Such vulnerabilities may include unauthorized access, or unauthorized data manipulation. The results of the analysis are used for suggesting ways to correct or remedy the threats.

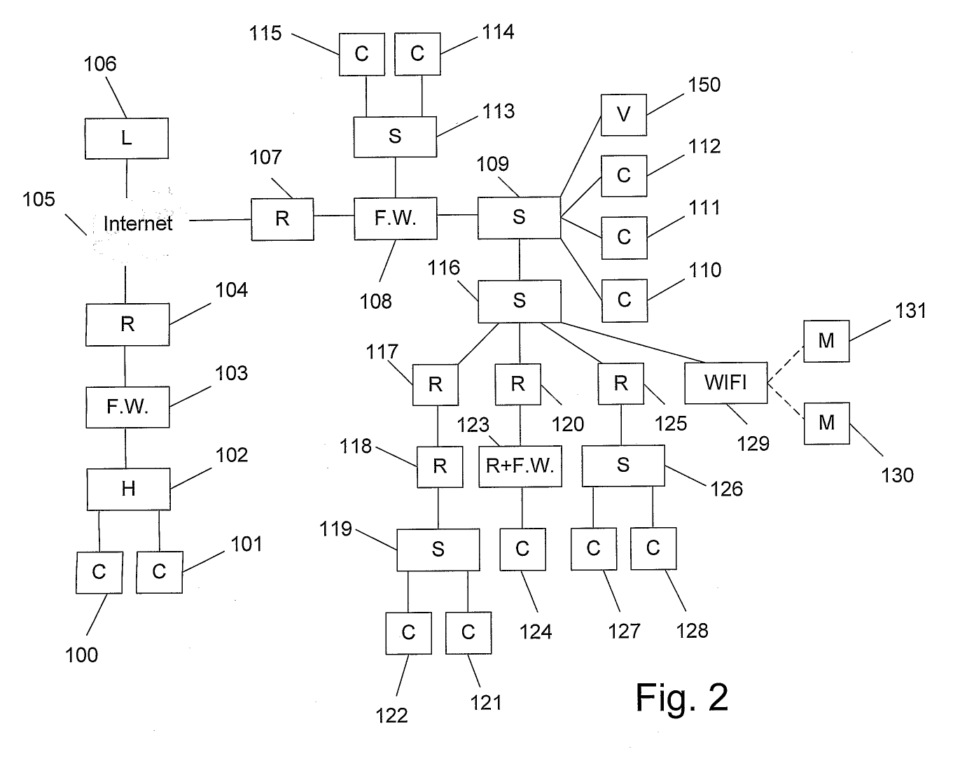

The function and structure of the system of the invention will now be elaborated. The system will be described with reference to the exemplary network of FIG. 2. In the network of FIG. 2, the following elements exist:
C—computer or server;
L—a user connected through the internet;
R—router;
S—switch;
F.W.—firewall;
R+F.W.—a combination of router and firewall;
M—mobile device;
WAP—wireless access point;
H—Hub;
V—The system of the present invention.

The system of the invention V is installed on a computer or appliance that is connected to the network. The system of the invention V is indicated as numeral 150 in FIG. 2.

An example for the operation of system V is followed. Upon connection of the system V (150 in FIG. 2), the mapping unit begins to map the network.

At the first stage, the mapping unit 10 finds the IP address of network element 109, in this case a switch, and sends the IP address of the switch to the profiling unit 11.

Upon receiving the IP address of element 109, the profile unit inquires element 109, and finds that the element is a switch. The profile unit then forms a profile record, and conveys the same to the mapping unit 10. As the profile shows that element 109 is a switch, which is one of a networking equipment type, the mapping unit concludes that it should further investigate the switch. The mapping unit then investigates the tables of switch 109 (such as ARP tables, CAM tables, VLAN tables, routing tables, and interfaces tables) in order to fine neighboring elements of switch 109.

Following the investigation, mapping unit 10, in its second step, may find the IP addresses of the neighboring network elements 108, 110, 111, 112 and 116. In a similar manner, the finding of said latter IP addresses are reported sequentially to the profiling unit 11, which finds the profiles of each of the network elements 108, 110, 111, 112 and 116. Upon receipt of the profiles of said elements 108, 110, 111, 112 and 116 from the profiling unit 11, the mapping unit may continue “crawling” the network, and each time a new element is found, this element is reported to the profiling unit 11 for profiling and the procedure continues in a manner as described.

It should be noted that the profiling unit 11 and the mapping unit 10 operate simultaneously, as each of said elements operate each time on a single network element. As will be further elaborated hereinafter, this simultaneous and incremental operation results in a significant reduction of processing time.

Each time a new IP address of an element is found by mapping unit 10, a topology record relating to this element is transferred to the MS unit 13. The topology record generally includes only the IP address of the element, but in the case of networking equipment (switch, router, firewall, etc.), the records also include the additional information gathered for that element relating to links and configuration to neighboring elements. Said additional information is obtained from the tables of the networking equipment.

Upon receipt of each of the IP addresses of elements 109, 110, 111, 112, and 108, the profiling unit 11 investigates each element, and builds a profile record for that IP. The profile record may include one or more of the following information:
a. Operating system name and version;
b. Open ports;
c. Running services;
d. Installed patches;
e. Configuration (such as registry configuration);
f. Supported protocols;
g. Running services detailed information;
h. Vendor;
i. Build number;
j. Hardware identification;

For a computer or server, parameters a-f including are relevant. For a networking equipment, items a, h, I, and j are relevant. For example, the record for computer 110 may include the following parameters:
a. Windows XP Professional Edition™;
b. Ports nos. 135 and 139;
c. Services RPC;
d. No installed patches;
e. The relevant items from the registry database of that computer;
f. TCP, UDP, and ICMP.

For switch 109 the profile record may include the following parameters:
a. CISCO IOS 12.0;
b. CISCO;

As said, each profile record, when formed for an element, is transferred also to the VA unit. For example, the profiles of elements 109, 110, 111, and 112, and 108 are provided sequentially in this order to the VA unit 12.

The VA unit has a database of vulnerability assessment tests, and a test table which corresponds each parameter in the received profile record to a list of relevant tests for that parameter. Then, the VA unit performs each one of the selected relevant tests on the corresponding element. An example for a test which may be performed on the computer element 110, may be “RPC Buffer Overflow test” for determining whether this computer is vulnerable to an RPC buffer overflow, for example by the known virus Blaster. For each test, the result is formed in a Passed/Fail (or True/False) manner, wherein “Passed” (or “True”) means that the element is not vulnerable, and “False (or “Failed”) means that the element is vulnerable. Each test result, whenever available, is reported separately to the MS unit 13. For example, if computer 110 fails the said RPC test, the VT result that is reported to the MS unit may be in the following form: IP address of unit 110, the relevant port on which the test was performed, the test ID, and a False indication.

The MS unit 13 receives from the map unit 10 topology records. From the topology records, the MS unit builds step by step a model of the full network. Until the full model is built, the MS unit can still perform partial simulations, and can provide partial results, that in many cases provide information which can practically be used to remedy at least some of the detected vulnerabilities. By the time that the VA unit 12 provides the VT results relating to a specific element to the MS unit 13, it can be assumed that the MS unit already received the topology record relating to that element, and it has been added to the network model. For example, by the time that the MS unit receives the VT results from the VA unit 12 relating to the computer element 110, it can be assumed that the model the at the MS unit already includes at least the computers 110, 111, and 112, the switch element 116, and the firewall 108. From the VT results that are received from the VA unit 12, the MS unit performs a quick analysis for each element. Based on the type and essence of the tests that the element has failed, a conclusion is made regarding the vulnerability of that element, and a corresponding vulnerability grade is given to that element.

Preferably, the following three grades are used:
VUL=0: There is no known vulnerability for this IP;
VUL=1: This vulnerability class may cause a local disruption to the normal operation of this element, but this element cannot be used for escalating the attack for causing damage to other devices. For example, a data manipulation vulnerability or a denial of service is included in this vulnerability class.
VUL=2: The vulnerability of this element may be used in order to run arbitrary code on this element, and from this element to exploit vulnerabilities of other elements. For example, if the tests show that one can take control of this element in order to manipulate data of another computer or data base, such a vulnerability will receive vulnerability grade VUL=2.

Having the grade for each element, the grades are marked on the model for each element.

All the operations described above are incremental. Each of the map unit 10, the profiling unit 11, and the VA unit 12 operate each time on only one element (that may be different in each of said units). The only unit which incrementally builds the model and views a larger structure of the network beyond a specific element, is the MS unit 13.

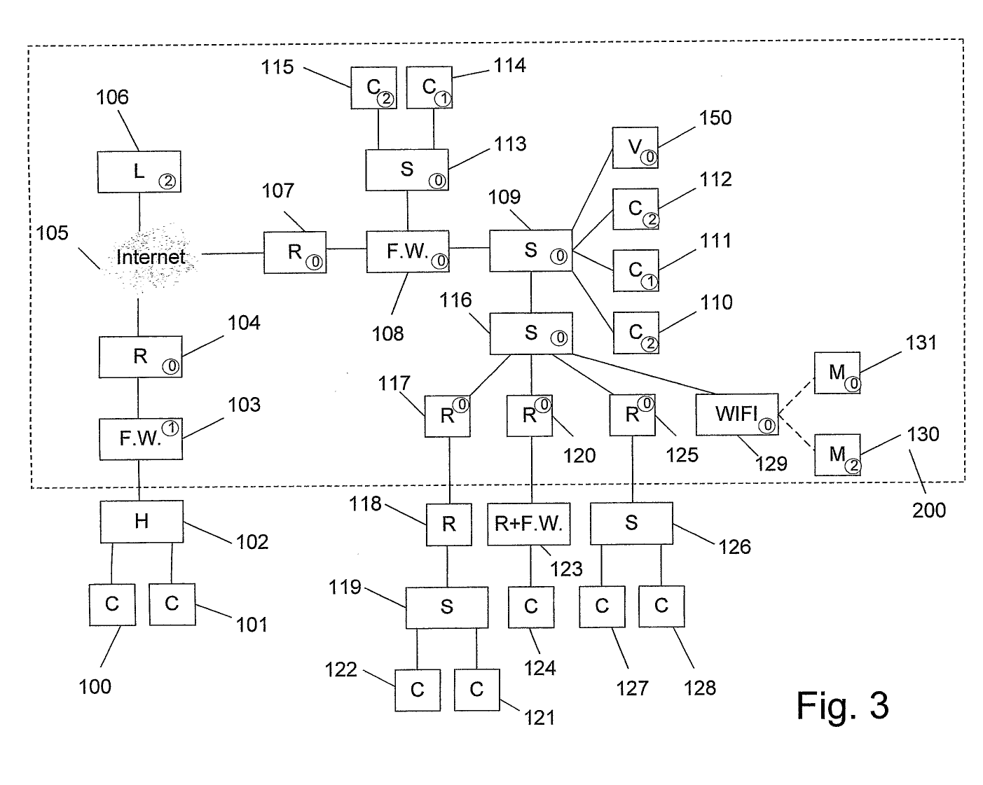

FIG. 3 shows an example for the operation of the MS unit at some time T. At time T, the incremental building by the MS unit 13 of the network model is indicated in FIG. 3 by the dashed line. This, still partial model, is indicated as model 200. The grades that have been found for each element are encircled within the symbol representing the element.

Each time an element is added to the model and a grade is given to that element, a simulation is made for determining the implication of the vulnerability of the added element on the entire network (that may be partial at some times until the full model is built).

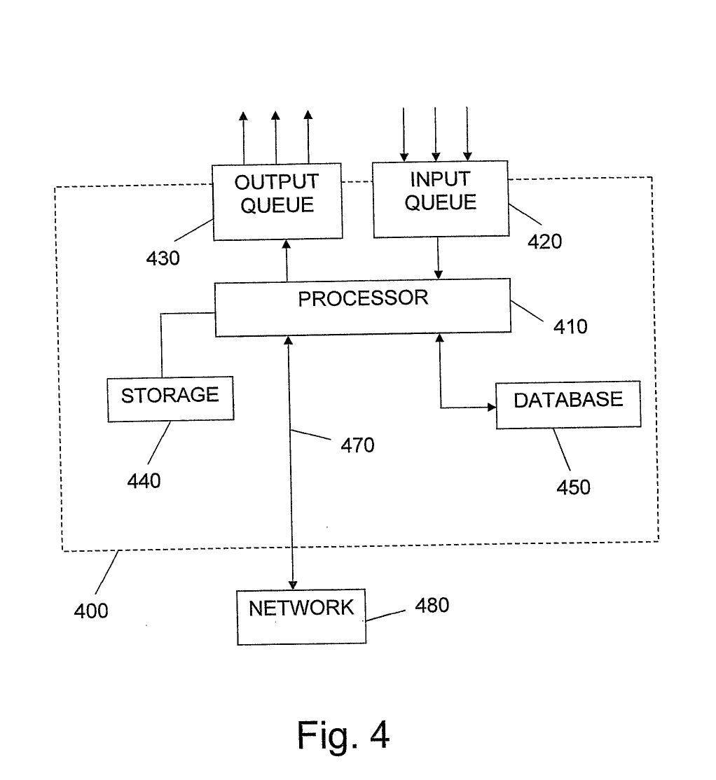

Referring to FIG. 3, it should be noted that the network equipment rules are also reported from the mapping unit 10 to the MS unit and applied to the model. For example in the partial model 200 of FIG. 4, the firewall 108 rules may indicate that the traffic from router 107 may reach computer 115 at port 80. As shown, this computer 115 has a VUL=2. The firewall 108 rules may also indicate that all traffic from computer 115 may reach also computer 112, which also has vulnerability grade VUL=2. Computer 111 is an important server running a database of the company, and the vulnerability grade found for this computer is VUL=1. Router 107 connects the Internet 105 to the firewall with no restrictions Switches 113 and 109 allow traffic between all their connected elements. Now, a potential threat (such as a hacker, warm, virus, spyware, Trojan, etc.), that may originate from computer 106 connected to the Internet, may legitimately use the predefined authorization rules of router 107, of firewall 108, and of switch 113 in order to reach computer 115. Furthermore, this threat may run arbitrary code on computer 115, and use the network legitimate predefined ruled in order to reach and exploit computer 112 having VUL=2. This can be observed having the vulnerabilities indicated in FIG. 3, and given said predefined rules. Now, since computer 112, and computer 111 are connected to the same switch 109, and computer 112 was exploited, and arbitrary code can be executed, a data manipulation can be performed on computer 111, which, as said, is a high-importance computer.

The MS unit 13 of the present invention, by having the model (even when partial), the said given predefined rules, and the vulnerability grades of each element, calculates and provides all the possible routes that can be exploited. The system can even mark each route by its severity and/or importance level.

The simulation is repeated and updated each time a new element is found, added to the model, or removed from it (as reported from the mapping unit 10), or when a new VT test is reported to the MS unit. Each time such an update is received, a calculation relating only to the effect of this update is made, requiring maximum of O(N) iterations of O(1), wherein N indicates the number of elements existing in the model. It should be noted that the accumulated results of the simulation are saved, and updated. Each time an element is added, a large portion of the model is not changed, and therefore the older, accumulated and learned simulation results, when considered and used, significantly reduce the amount of the required calculations. Thus, the average number of calculations required is even lower than O(N). This is, as opposed to the prior art, in which each time a new assessment of the network is necessary, the entire system has to be initiated and run from the beginning, resulting in a very large number of calculations, in the range of O(N³), or when optimized above O(N²).

The structure of each of the units 10, 11, 12, and 13 is shown in FIG. 4. According to the present invention, the basic structure of all the said four units is identical. Each unit comprises a processor 410, database 450, a storage 440, input queue 420, and output queue 430. The database 450 stores information which is used by the processor to carry out its tasks. The database is updated every relatively long time period. The processor temporary accumulated results may be stored in storage 440. The updates from the other unit or units are received through the input queue, and the outputs from the unit to other units are supplied through the output queue 430. The access of the unit to the network is 480 is obtained through line 470.

In the case of the mapping unit 10, the database 450 may contain the commands for extracting the tables from networking equipments. The storage 440 may contain the tables, and extracted IPs to enable the mapping unit to compare whether a new update has been determined, as there is no need to provide old, known and unchanged information to other units of the system (in this case the profiling unit 11, and the MS unit 13). The input queue contains sequential profile records that are received from the profiling unit 11, and the output queue 430 contains IPs that are provided to the mapping unit 11, and topology records that are provided to the MS unit 13.

In the case of the profiling unit 11, the database 450 may contain OS information, vendor information, and other information relating to how to determine the profile of each element. The storage 440 may contain the accumulated profiles obtained from the already investigated network elements, to enable the profile unit to compare and determine whether a new or updated profile has been detected, as there is no need to provide old, known and unchanged information to other units of the system (in this case the mapping unit 10, and the VA unit 12). The input queue contains IPs that are received from the mapping unit 10, and the output queue contains sequential profile records that are conveyed to the VA unit 12 and to the mapping unit 10.

In the case of the VA unit 12, the database 450 may contain the tests that have to be performed, and a table indicating the specific tests that have to be run on each element. The storage 440 may contain the accumulated VT results already obtained for each network element, to enable the VA unit 12 to compare and determine whether a new or updated test result has been obtained, as there is no need to provide old, known and unchanged VT information to the MS unit 13. The input queue contains profile records that are received from the profiling unit 11, and the output queue contains sequential VT results that are obtained and conveyed to the MS unit 13.

In the case of the MS unit 13, the database 450 may contain the information relating to the impact results of test failures on the vulnerability grade given to each element (VUL=0, 1, or 2). The storage 440 may contain the accumulated model already obtained for each network element, the grade given to each element, and the accumulated simulation results. The input queue 420 contains VT results that are received from the VA unit 12, and the output queue contains sequential results that are obtained and conveyed to the user interface.

It should be noted that in order to enable the system to operate in an optimized manner, the information in the abovementioned databases of the four system units have to be periodically updated.

As described, the system of the present invention comprises four units which all operate in a simultaneous, incremental manner. Each of the mapping, profiling, and vulnerability assessment units operates at any specific time on one network element. The only unit which views, evaluates, and operates on a scale larger than one element, is the MS unit.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A simultaneous system for finding and assessing vulnerabilities in a network, comprising:
A. A mapping unit for:
a. scanning the network, and each time a new element is found, reporting its IP address to a profiling unit;
b. sequentially receiving from the profiling unit profile records of said newly found elements;
c. sequentially extracting tables from those elements which their profile record indicates that they are of the network equipment type; and
d. sequentially reporting to a modeling and simulating unit topology records which include said found IPs, and for those elements being of a network equipment type, said topology records also include said extracted tables;
B. A profiling unit for sequentially receiving IP addresses of network elements from the mapping unit, investigating each of said elements, forming a profile record for each of said elements, and sequentially transferring said profile records to both the mapping unit and to a vulnerability assessment unit;
C. A vulnerability assessment unit for:
a. sequentially receiving profile records from the profiling unit;
b. determining a list of those vulnerability tests that have to be performed on each element;
c. performing for each element those vulnerability tests that are included in its corresponding list, and determining for each test a passed or failed result; and
d. sequentially reporting to a modeling and simulation unit for each performed test, the IP of the element, the identity code of the element, and the passed or failed result;
and
D. A modeling and simulation unit for:
a. sequentially receiving topology records from the mapping unit, and each time a topology record is received, adding or subtracting respectively the corresponding element from a model of the network which is maintained at the modeling and simulation unit;
b. sequentially receiving from the vulnerability assessment unit VT results;
c. sequentially analyzing the model currently existing at the modeling and simulation unit for the possibility of exploiting vulnerabilities of the network.

2. System according to claim 1, wherein each of the mapping, profiling, and vulnerability assessment units operate on only one element at each given time, and the modeling and simulation unit operates on the accumulated network model structure at each given time.

3. System according to claim 1, wherein each topology record of a network element comprises at least the IP of a network element.

4. System according to claim 3, wherein when the element is of a network equipment type, each topology record further comprises also the tables of the element.

5. System according to claim 1, wherein each profile record of a network element comprises at least the parameters that characterize the specific element;

6. System according to claim 1, wherein each profile record of a network element comprises one or more of the following parameters: the IP address of the element, the operating system name and version open ports, running services, installed patches, configuration, registry configuration, supported protocols, running services detailed information, vendor, build number, and hardware identification.

7. System according to claim 1, wherein the analyzing by the modeling and simulation unit involves the step of providing a vulnerability grade to each element of the model, based on the received vulnerability test results.

8. System according to claim 7, wherein the analyzing by the modeling and simulation unit further involves, best on the vulnerability grade given to each element, the step of finding vulnerable routes for attacking the network elements.

9. System according to claim 1, wherein each of the mapping, profiling, vulnerability assessment, and modeling and simulation units comprise:
a. an input queue for sequentially receiving inputs from one or more other units;
b. an output queue for sequentially outputting outputs to one or more other units;
c. a database;
d. a storage for storing temporary processing results; and
e. a processor for: receiving inputs from other units, using data in the database and the storage in order to obtain results, and for sequentially outputting results to other units.

10. System according to claim 9, wherein when the unit is a mapping unit, the database contains commands for extracting tables from networking equipments, the storage contains tables and history of detected IP results for comparison, the input queue contains sequential profile records, and the output queue contains IP addresses of detected elements to be provided to the mapping unit, or topology records to be provided to the modeling and simulation unit.

11. System according to claim 9, wherein when the unit is a profiling unit, the database contains OS information, vendor information, and other information relating to how to determine the profile of each element, the storage contains the profiles obtained from the already investigated network elements for comparison, the input queue contains IPs that are received from the mapping unit 10, and the output queue contains sequential profile records that are conveyed to the VA unit and to the mapping unit.

12. System according to claim 9, wherein when the unit is a vulnerability assessment unit, the database contains the tests that have to be performed, and a table indicating the specific tests that have to be run on each element, the storage contains the accumulated vulnerability test results already obtained for each network element for comparison, the input queue contains profile records that are received from the profiling unit, and the output queue contains sequential vulnerability test results that are obtained and conveyed to the modeling and simulation unit.

13. System according to claim 9, wherein when the unit is a simulation and modeling unit, the database contains the information relating to the impact results of test failures on the vulnerability grade given to each element; the storage contains the accumulated model already obtained for each network element, the grade given to each element, and the accumulated simulation results; the input queue contains vulnerability test results that are received from the vulnerability assessment unit; and the output queue contains sequential results that are obtained and conveyed to the user interface.
